(19) United States
(12) Patent Application Publication
(10) Pub. No.: US 2014/0181709 A1
(43) Pub. Date: Jun. 26, 2014

(54) APPARATUS AND METHOD FOR USING INTERACTION HISTORY TO MANIPULATE CONTENT

(71) Applicant: NOKIA CORPORATION, Espoo (FI)

(72) Inventor: Roope Aleksi Rainisto, Helsinki (FI)

(73) Assignee: NOKIA CORPORATION, Espoo (FI)

(21) Appl. No.: 13/724,930

(22) Filed: Dec. 21, 2012

(51) Int. Cl. G06F 3/0481

(52) U.S. Cl. CPC G06F 3/0481
USPC 715/765

(57) ABSTRACT

An apparatus, method, and computer program product are described that provide a way for a user's interaction history with an object to be considered such that the user's preferences for consuming the object may be anticipated. A record that includes an interaction history of an object may be accessed, and a manipulation operation may be determined based at least in part on the interaction history. The manipulation operation may then be automatically applied to the object, so as to prepare the object for consumption by the user.

### TECHNOLOGICAL FIELD

Embodiments of the present invention relate generally to manipulating content to provide the content to a user in a format that is optimal for the desired interaction.

### BACKGROUND

Advancements in mobile device technology have provided mobile devices, such as cellular telephones and portable digital assistants (PDAs), that have increased functionality and allow users to view and interact with various different types of content. However, the portable nature of mobile devices generally means that the size of the displays provided on the mobile devices is relatively small. Thus, users may, at times, only see portions of the information they have accessed depending on how much information can be presented within the area of the display provided. As a result, users may need to zoom, pan, and otherwise interact with the content to ensure that the relevant portion of the content is being presented.

Accordingly, it may be desirable to provide an improved mechanism for preparing content for user consumption.

### BRIEF SUMMARY OF EXAMPLE EMBODIMENTS

Accordingly, embodiments of an apparatus, method, and computer program product are described that provide a way to consider a user's interaction history with an object and, based on the interaction history, determine a manipulation operation to apply to the object to prepare the object for consumption by the user.

In particular, embodiments of an apparatus for determining a manipulation operation to be applied to an object may include at least one processor and at least one memory including computer program code. The at least one memory and the computer program code may be configured to, with the processor, cause the apparatus to access a record comprising an interaction history of an object, determine a manipulation operation based at least in part on the interaction history, and apply the manipulation operation to the object. The interaction history may comprise execution of an operation by a user. Alternatively or additionally, the interaction history may comprise locations of user interaction within the object. The interaction history may comprise at least one of a duration of user interaction at a particular location, a frequency of user interaction at a particular location, or an order of user interaction.

In some embodiments, the at least one memory and the computer program code may be further configured to, with the processor, cause the apparatus to access the record by accessing a plurality of records, each record being associated with a different interaction session with the object. The at least one memory and the computer program code may be further configured to, with the processor, cause the apparatus to determine a manipulation operation by determining a trend in user interaction with the object based on the plurality of records accessed. In some cases, the manipulation operation may comprise a plurality of operations.

In other embodiments, a method and a computer program product are described for accessing a record comprising an interaction history of an object; determining a manipulation operation based at least in part on the interaction history; and applying the manipulation operation to the object.

The interaction history may comprise locations of user interaction within the object. In some cases, the interaction history may comprise at least one of a duration of user interaction at a particular location, a frequency of user interaction at a particular location, or an order of user interaction. Moreover, accessing the record may comprise accessing a plurality of records, each record being associated with a different interaction session with the object. Determining a manipulation operation may comprise determining a trend in user interaction with the object based on the plurality of records accessed. In some cases, the manipulation operation may comprise a plurality of operations.

In still other embodiments, an apparatus is described for determining a manipulation operation to be applied to an object. The apparatus may include means for accessing a record comprising an interaction history of an object; means for determining a manipulation operation based at least in part on the interaction history; and means for applying the manipulation operation to the object.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for determining a manipulation operation based on interaction history according to an example embodiment of the present invention;

FIG. 3 illustrates an apparatus by which a user can interact with an object according to an example embodiment of the present invention;

FIG. 4 illustrates a record including an interaction history from a first interaction session with the object of FIG. 3 according to an example embodiment of the present invention;

FIG. 5 illustrates a record including an interaction history from a second interaction session with the object of FIG. 3 according to an example embodiment of the present invention; and

FIG. 6 illustrates a flowchart of methods of determining a manipulation operation based on interaction history according to another example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As noted above, mobile terminals, including devices such as portable digital assistants (PDAs) and cellular telephones, are becoming smaller in size to allow for greater portability to the user. With the decrease in size of such devices, however, comes a decrease in the space available for displaying information. In other words, the size of the viewing area through which content (e.g., mapping applications, images, webpages, etc.) is presented to the user has become more limited as a result of more compact devices.

At the same time, the content that is available for user consumption is ever increasing in its dimensions for optimal display and its complexity (e.g., linking between different content objects to navigate from one object to another). As a result, a user may need to perform several operations via user interaction with the presented object to prepare the object to be optimally presented on the available size of the device's display, and such devices may be provided with additional functionality to allow the user to interact with and manipulate the object. For example, a user may be able to zoom in on certain portions of the displayed content to read small print and may be able to pan (e.g., shift the displayed image in a particular direction) to view portions of the object that were previously outside the display's viewing area. In addition, the user may be able to expand certain aspects of the displayed content, such as to view details regarding a particular displayed icon or indication, launch a program, or open a new window within the viewing area, etc.

For example, the object presented to a user may be a map of a large geographic area, and the user may need to pan and/or zoom in or out with respect to a portion of the map to view the details the user is looking for. As another example, the object may be a webpage, a high-resolution picture, or a similar item of content. As used herein, the term “object” refers generally to a content item that is presentable to the user for consumption (e.g., for viewing, to receive user input, or to provide output to the user), as well as any associated data enabling its presentation (e.g., metadata).

The user's interaction with the object (e.g., selecting certain links, clicking on certain portions of the displayed content, applying zoom operations, moving or rearranging the displayed content, etc.) to prepare the object for consumption according to the user's needs and taste can be time consuming and may, in some cases, involve an element of trial and error. At the same time, analyzing a history of the user's interaction can provide important information regarding how the user wishes to consume the content and may, in some cases, allow the user's needs to be anticipated.

Accordingly, embodiments of the present invention provide a way to consider a user's interaction history with an object and, based on the interaction history, determine a manipulation operation to apply to the object to prepare the object for consumption by the user. Embodiments of the present invention thus learn from a user's past interactions with the object to anticipate the user's preferences for consuming the object, thereby saving the user from having to interact with the object manually to get it in the preferred form for consumption.

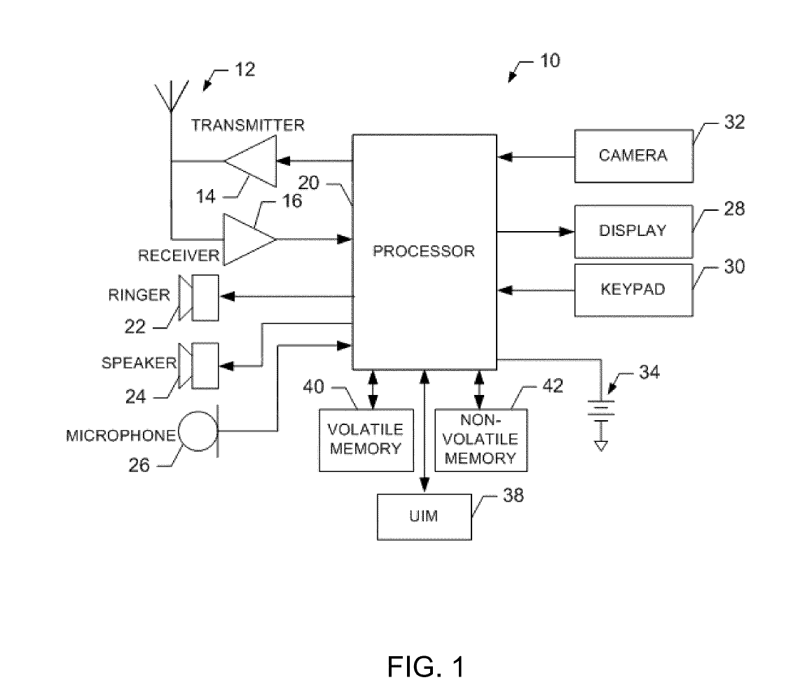

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

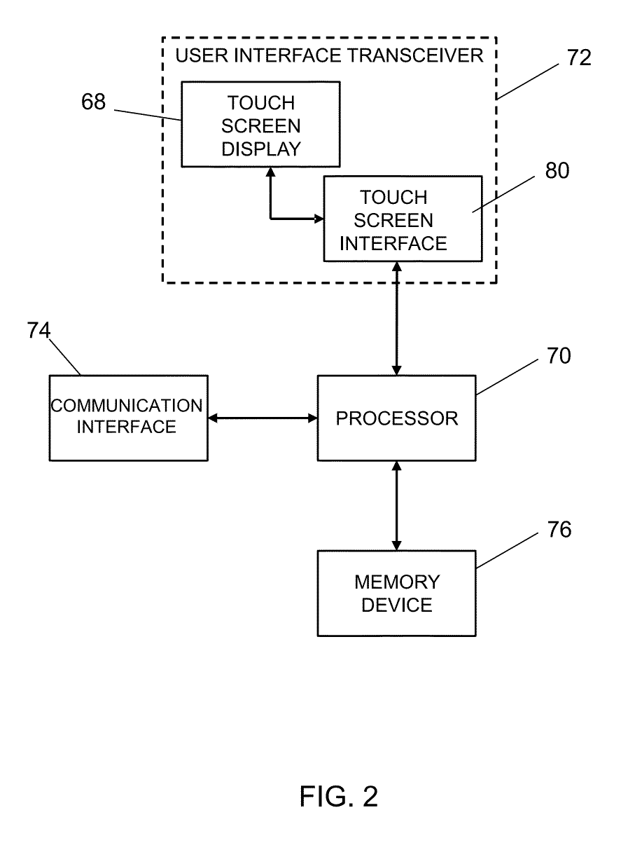

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include a proximity component and/or an orientation component, as described below. The signals may further include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element 32 in order to capture images or video of objects, people, and places proximate to the user of the mobile terminal 10. The mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for determining a manipulation operation to be applied to an object. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer, a tablet, a mobile telephone, or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for determining a manipulation operation to be applied to an object, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 2, the apparatus 50 for determining a manipulation operation to be applied to an object may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive touch inputs at the touch screen display 68 and to analyze and/or modify a response to such indications based on corresponding user actions that may be inferred or otherwise determined responsive to the touch inputs.

With continued reference to FIG. 2, in an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct, or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the inputs. Following recognition of a touch event, the touch screen interface 80 may be configured to determine a classification of the touch event and provide a corresponding function based on the touch event in some situations.

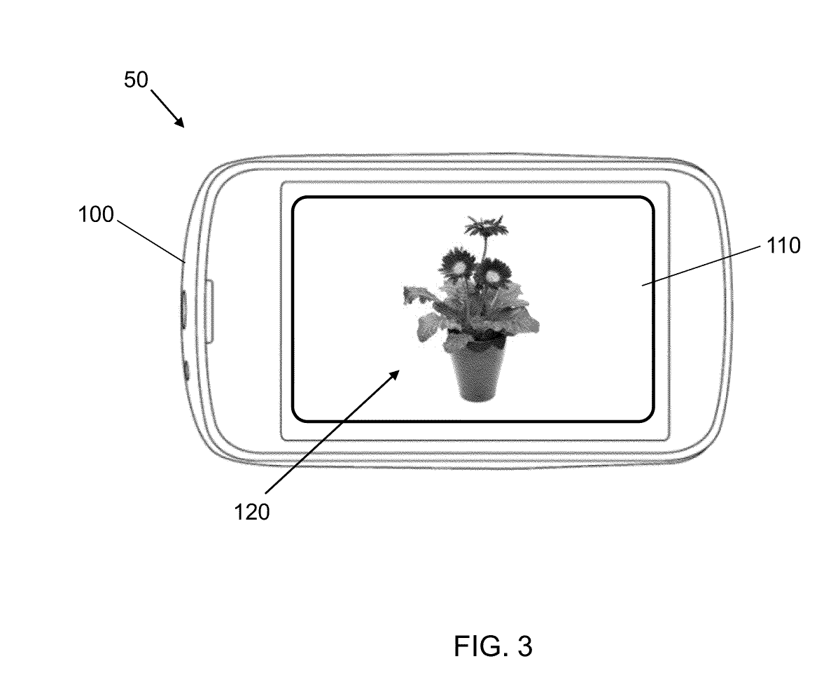

Turning now to FIG. 3, in general, an apparatus 50 is provided, such as an apparatus embodied by the mobile terminal 10 of FIG. 1 (e.g., a cellular phone) that has or is otherwise associated with a display and a user input interface. As noted above, the user input interface may be a user input device that is separate from the display (such as a keypad and/or mouse), or the user input interface may be embodied by the display, such as by a touch screen display 68 of FIG. 2. For ease of explanation, the example of an apparatus 50 embodied by a cellular phone 100 having a touch screen display 110 is used herein.

As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to at least provide for the presentation of content upon the display 110. The content that is viewable given the dimensions of the display may only represent a portion of an object 120. Thus, as noted above, the user may need to interact with the object 120, such as by providing inputs to effect a zooming operation, a panning operation, a navigation operation (e.g., selecting a link displayed on a webpage to navigate to the linked webpage content), a cropping operation, or combinations of such operations and/or other operations to place the object 120 in a state for presentation to the user according to the user's needs and preferences. Moreover, only certain portions of the object 120 may be of interest to the user, and the user's interaction with the object may reflect how the user accesses and consumes those portions of interest.

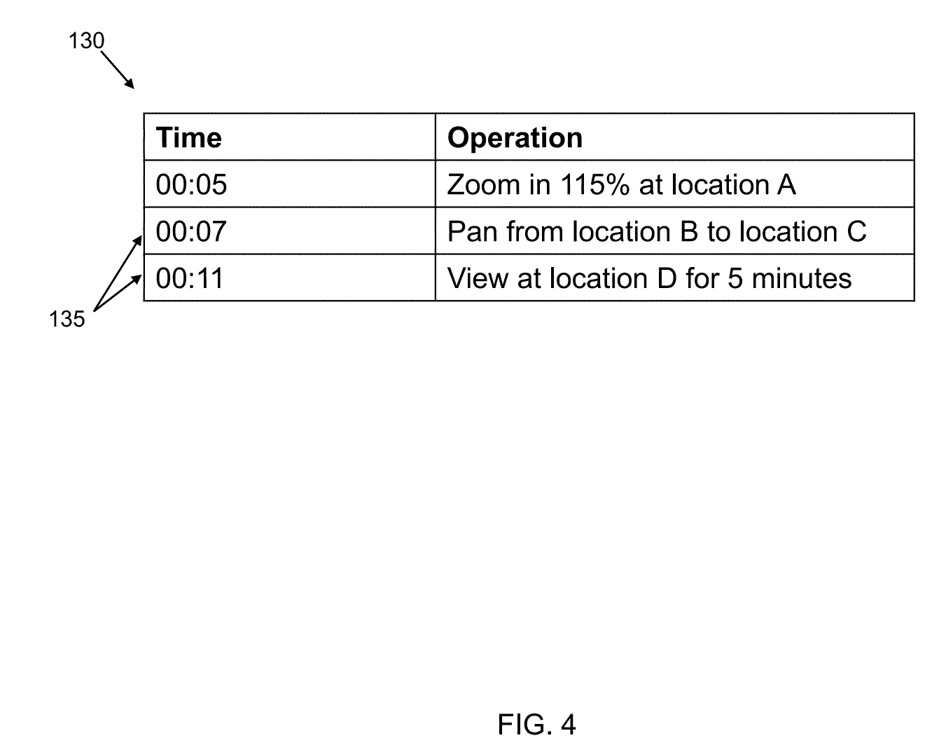

One or more user interactions with the object 120 may be recorded and stored in a memory for subsequent access, such as in the memory device 76 of FIG. 2 or another memory accessible to the processor 70. As such, in some embodiments, a record comprising an interaction history of an object may be created. A representation of a record 130 is shown as a table, for example, in FIG. 4. The record may, for example, be stored in metadata associated with the object or in a separate file that is linked to or otherwise associated with the object.

The record 130 may include various pieces of data describing the user's interaction history with a particular object. The record 130 shown in FIG. 4 may comprise an interaction history of the object 120 of FIG. 3, as an example. In this example, the interaction history may include the execution of an operation by the user, such as a zooming operation (e.g., zoom in or zoom out), a panning operation, a navigation operation, and other operations. The interaction history of the record 130 may, in some cases, comprise locations of user interaction within the object 120. For example, in the record 130 depicted in FIG. 4, the user executed a zoom in operation at location A and a panning operation at location B (e.g., where the user clicked to initiate the panning operation). Other information describing the user's interaction with the object may also be provided, such as the percentage of zooming (115% in the depicted example) and the location to which the object was panned (location C, e.g., where the user ceased panning). In some embodiments, the locations may be described using X-Y coordinates of the viewing area of the display 110 of FIG. 3 or coordinates with respect to the entire object (both displayed and undisplayed portions). The location may, in some cases, refer to a portion of the object, such as a window, a tab, a link, or some other area larger than the coordinate point of user interaction.

Moreover, in some embodiments, the interaction history may comprise a duration of user interaction at a particular location, a frequency of user interaction at a particular location, and/or an order of user interaction. For example, one or more entries 135 of the record 130 of FIG. 4 may be associated with a time at which the user interaction occurred. In the depicted example, the zooming operation may be associated with a time of 00:05; the panning operation may be associated with a time of 00:07, and a viewing operation (described below) may be associated with a time of 00:11. The times may be real times (e.g., the actual time of day at which the user interaction occurred), or the times may be relative, such as starting at 00:00 each time the user begins interacting with a new object and/or each time a new record is created.

The duration of user interaction at a particular location may be derived from the times associated with the start and stop of a particular operation or, in some cases, may be included in the description of the interaction. For example, the record 130 of FIG. 4 describes a view operation at location D with a duration of 5 minutes. This may, for example, reflect a period of no user interaction with the object or relatively little movement of the object by the user for 5 minutes. The location D may, in this example, be a location within the object that is displayed at the center of the display 110 of FIG. 3, generally representing the area of the object that the user was viewing.

As noted above, the interaction history may also include a frequency of user interaction at a particular location. For example, in a case where the object is a webpage that includes links to other pages, the interaction history may include the number of times a particular link is selected.

In addition to the operations themselves that are executed, the order in which the user executes the operations (e.g., the order of user interaction) may be included in the interaction history. For example, the record 130 of FIG. 4, by virtue of the associated times, shows that, in this example, a zoom in operation was followed by a panning operation, which was followed by a view operation. The order of user interaction may, in some cases, reflect the user's progression through the object (e.g., that the user viewed a certain portion of the object, then proceeded to view a different portion).

According to embodiments of the present invention, the interaction history, which may include the examples of operations and details regarding those operations described above as well as countless others, may be used to determine how best to manipulate an object with which the user wishes to interact (e.g., based on how the user has interacted with that object, or similar objects, in the past).

Accordingly, in some embodiments, the at least one memory and the computer program code may be configured to, with the processor, cause the apparatus 50 to at least access a record comprising an interaction history of an object, such as the record 130 of FIG. 4 relating to the object 120 of FIG. 3. The at least one memory and the computer program code may be further configured to, with the processor, cause the apparatus 50 to determine a manipulation operation based at least in part on the interaction history and to apply the manipulation operation to the object.

The manipulation operation may include one or more operations (such as zooming operations, panning operations, navigation operations, etc.) that are configured to place the object in a more useful state for presentation and consumption by the user, based on the user's interaction history. In other words, by analyzing the record of interaction history of an object, the apparatus 50 may be caused to determine one or more operations that it is anticipated the user would want to apply to the object (e.g., the manipulation operation), and the apparatus may then be caused to apply the manipulation operation to the object automatically (without requiring input from the user), such as when the user first initiates interaction with the object (e.g., opens a webpage, launches an application, etc.).

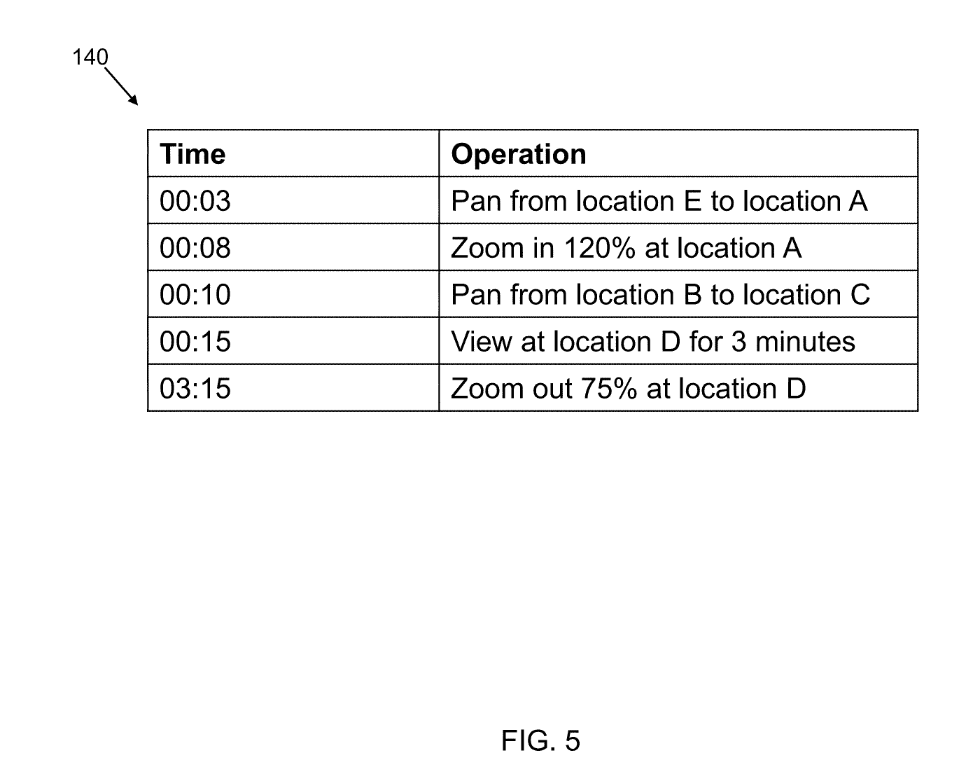

In some embodiments, the at least one memory and the computer program code may be configured to, with the processor, cause the apparatus 50 to access the record by accessing a plurality of records. In this regard, each record may be associated with a different interaction session with the object. For example, the record 130 shown in FIG. 4 may be associated with a first interaction session with the object (such as a particular period of interaction that the user has with the object), and the record 140 shown in FIG. 5 may be associated with a second interaction session with the object (such as another period of interaction that the user has with the object). The interaction session may, for example, be defined by the time a user first starts to interact with the object to the time the user ceases to interact with the object or begins interacting with a different object.

The at least one memory and the computer program code may be further configured to, with the processor, cause the apparatus 50 to determine a manipulation operation by determining a trend in user interaction with the object based on the plurality of records accessed. In some embodiments, the plurality of records may relate to different objects having similar characteristic (e.g., the same type of content) created by the user, whereas in still other embodiments the records may relate to the same or similar objects created by multiple different users. Accordingly, in some cases, the information in the records may be extracted, compiled, and/or collated into various data formats and structures, such that one or more particular records in their entirety may not be needed.

With reference to FIGS. 4 and 5, the apparatus 50 may, for example, be caused to access and analyze the record 130 of FIG. 4 and the record 140 of FIG. 5. In analyzing these records 130, 140, the apparatus 50 may be caused to discern a trend, a pattern, or some other predictive tool for determining the user's desired interaction with the object. For example, it may be determined that the user has a particular interest in the content at location A (based on the interaction history describing a zoom in operation at this location during both interaction sessions), as well as an interest in the content at location D (based on the view operation during both interaction sessions). At the same time, however, it may be determined that the user's interest in the content at location D is waning based on the decrease in time the user spent viewing the content at location D during the interaction session associated with the record 140 as compared to during the interaction session associated with the record 130 (assuming that the interaction session associated with the record 140 occurred after the interaction session associated with the record 130). Thus, in this example, a manipulation operation may be determined that provides a zoom in operation at location A upon the user's first accessing the object based on the user's apparent interest in the content at location A. The manipulation operation in this example may further provide a window to display the content from location D alongside the content of location A based on the user's apparent interest in the content at location D.

Examples will now be described in general terms in the context of different applications (e.g., different objects) in which embodiments of the invention may be used.

The object may, for example, be a map object, such as an object that provides the user with mapping content in the form of a visual representation of a geographic area, driving directions, information about attractions, route planning, etc. Based on a user's interaction history, embodiments of the invention described above may determine which geographic areas of the map are most interesting to the user. This determination may be modified or adjusted over time, such as to take into account how the user's interests change over multiple interaction sessions. Based on the user's interest in certain regions of the map, it may be determined that an event or noteworthy occurrence is taking place at the region of interest, and, as a result, the manipulation operation may include bandwidth optimization operations, such as operations that prioritize the downloading of content associated with the region of interest over other content, operations that update files associated with the region of interest more frequently than other content, etc. The manipulation operation that is determined may also place the map object in an initial position and initial zoom state based on the regions of interest to the user.

Moreover, in some cases, the behavior of multiple users may be accessed and analyzed to determine how a majority of users react to certain situations. For example, if the majority of users start to zoom out after seeing the map results for a given search term, the initial position and zoom state of the map object may, via the manipulation operation, automatically zoom out and pan when that search is conducted.

In other applications, the object may be an image object, such as a high-resolution image. Based on a user's interaction history with the object, a manipulation operation may be determined that automatically creates thumbnails or animated thumbnails of the image and publishes them to a gallery. If it is determined that a user frequently zooms in to a particular portion of the image, the thumbnail may be cropped to reflect that portion of interest to create a more useful thumbnail for the user. With respect to animated thumbnails, zooming and panning effects may be determined to create a “Ken Burns” style of animation.

In some cases, the manipulation operation may propose tags and tag locations for the image. For example, if it is determined that the user views a particular area of the image frequently, that area may be proposed as a likely recipient for a tag.

In addition, based on the interaction history, a manipulation operation may be determined that describes a cropping scenario for the image. For example, if the user starts to crop the image (e.g., a photograph), the crop frame may automatically “snap” to certain locations, or different cropping scenarios may be superimposed on the image based on the areas of the image the user views most frequently or for the longest amount of time. Cropping scenarios may be suggested, for example, to a user engaged in setting a wallpaper image or creating an animated wallpaper image for a home screen.

In still other cases, such as when the object is a webpage, the interaction history may provide information as to what portions of the webpage the user is reading and what portion the user is not reading. This information may be inferred, for example, based on the duration of time that an item of text remains displayed to the user and the size at which it is displayed. For example, if an item of text is displayed for more than n seconds at a size larger than m pixels (e.g., a readable pixel size), then it may be determined that the item of text is being read. Such information may be useful, for example, for determining optimal locations on a webpage for certain content, such as advertisements, and/or pricing for advertisements at certain locations on the webpage. In addition, when creating a bookmark for a webpage, a manipulation operation may be determined that creates a thumbnail of a relevant part of the webpage, based on the part of the webpage the user appears to be most interested in.

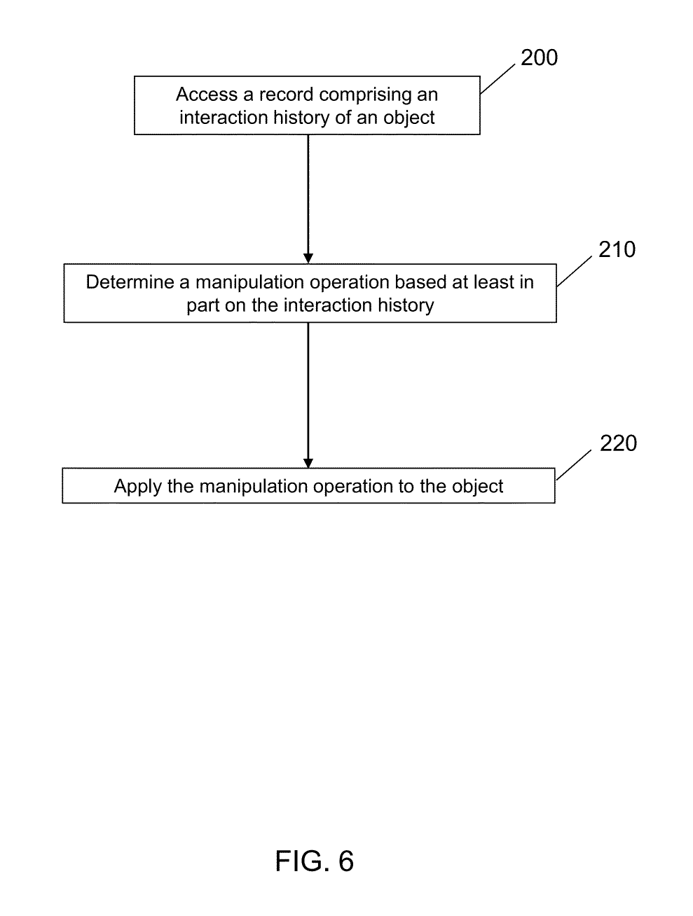

FIG. 6 illustrates flowcharts of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for determining a manipulation operation to be applied to an object, as shown in FIG. 6, includes accessing a record comprising an interaction history of an object at Block 200, determining a manipulation operation based at least in part on the interaction history at Block 210, and applying the manipulation operation to the object at Block 220. As described in the examples above, in some cases the interaction history may include the execution of an operation by a user. Additionally or alternatively, the interaction history may include locations of user interaction within the object. For example, the interaction history may include at least one of a duration of user interaction at a particular location, a frequency of user interaction at a particular location, or an order of user interaction. Moreover, the manipulation operation may comprise a plurality of operations, as described above.

In some embodiments, accessing the record may comprise accessing a plurality of records, each record being associated with a different interaction session with the object, and determining a manipulation operation may comprise determining a trend in user interaction with the object based on the plurality of records accessed.

In some embodiments, certain ones of the operations above may be modified or further amplified as described below. Furthermore, in some embodiments, additional optional operations may be included. Modifications, additions, or amplifications to the operations above may be performed in any order and in any combination.

In an example embodiment, an apparatus for performing the methods of FIG. 6 above may comprise a processor (e.g., the processor 70 of FIG. 2) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operation 200 may comprise, for example, the communication interface 74, the processor 70, the memory device 76, and/or a device or circuit for executing instructions or executing an algorithm for processing information as described above. Examples of means for performing operation 210 may comprise, for example, the processor 70, the memory device 76, and/or a device or circuit for executing instructions or executing an algorithm for processing information as described above. Examples of means for performing operation 220 may comprise, for example, the user interface transceiver 72, the processor 70, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
access a record comprising an interaction history of an object;
determine a manipulation operation based at least in part on the interaction history; and
apply the manipulation operation to the object.

2. The apparatus of claim 1, wherein the interaction history comprises execution of an operation by a user.

3. The apparatus of claim 1, wherein the interaction history comprises locations of user interaction within the object.

4. The apparatus of claim 3, wherein the interaction history comprises at least one of a duration of user interaction at a particular location, a frequency of user interaction at a particular location, or an order of user interaction.

5. The apparatus of claim 1, wherein the at least one memory and the computer program code are further configured to, with the processor, cause the apparatus to access the record by accessing a plurality of records, each record being associated with a different interaction session with the object.

6. The apparatus of claim 5, wherein the at least one memory and the computer program code are further configured to, with the processor, cause the apparatus to determine a manipulation operation by determining a trend in user interaction with the object based on the plurality of records accessed.

7. The apparatus of claim 1, wherein the manipulation operation comprises a plurality of operations.

8. A method comprising:
accessing a record comprising an interaction history of an object;
determining, via a processor, a manipulation operation based at least in part on the interaction history; and
applying the manipulation operation to the object.

9. The method of claim 8, wherein the interaction history comprises locations of user interaction within the object.

10. The method of claim 9, wherein the interaction history comprises at least one of a duration of user interaction at a particular location, a frequency of user interaction at a particular location, or an order of user interaction.

11. The method of claim 8, wherein accessing the record comprises accessing a plurality of records, each record being associated with a different interaction session with the object.

12. The method of claim 11, wherein determining a manipulation operation comprises determining a trend in user interaction with the object based on the plurality of records accessed.

13. The method of claim 8, wherein the manipulation operation comprises a plurality of operations.

14. A computer program product comprising at least one computer-readable storage medium having computer-executable program code portions stored therein, the computer-executable program code portions comprising program code instructions for:
accessing a record comprising an interaction history of an object;
determining a manipulation operation based at least in part on the interaction history; and
applying the manipulation operation to the object.

15. The computer program product of claim 14, wherein the interaction history comprises execution of an operation by a user.

16. The computer program product of claim 14, wherein the interaction history comprises locations of user interaction within the object.

17. The computer program product of claim 16, wherein the interaction history comprises at least one of a duration of user interaction at a particular location, a frequency of user interaction at a particular location, or an order of user interaction.

18. The computer program product of claim 14, wherein the program code instructions configured for accessing the record are further configured for accessing a plurality of records, each record being associated with a different interaction session with the object.

19. The computer program product of claim 18, wherein the program code instructions configured for determining a manipulation operation are further configured for determining a trend in user interaction with the object based on the plurality of records accessed.

20. The computer program product of claim 14, wherein the manipulation operation comprises a plurality of operations.
